(19) United States
(12) Patent Application Publication
(10) Pub. No.: US 2024/0217169 A1
(43) Pub. Date: Jul. 4, 2024

(54) PROCESS AND ASSEMBLY FOR ADDITIVE MANUFACTURING OF COMPONENTS BY MATERIAL EXTRUSION

(71) Applicant: Fraunhofer-Gesellschaft zur Förderung der angewandten Forschung e.V., München (DE)

(72) Inventor: Paul WEGWERTH, Hamburg (DE)

(73) Assignee: Fraunhofer-Gesellschaft zur Förderung der angewandten Forschung e.V., München (DE)

(21) Appl. No.: 18/289,118

(22) PCT Filed: May 3, 2022
(86) PCT No.: PCT/EP2022/061786

§ 371 Date: Nov. 1, 2023

(30) Foreign Application Priority Data
May 7, 2021 (DE) 10 2021 111 966.9

(51) Int. Cl. B29C 64/118; B29C 59/16; B29C 64/129; B29C 64/268; B33Y 10/00; B33Y 30/00; B33Y 40/00

(52) U.S. Cl. CPC B29C 64/118; B29C 59/16; B29C 64/129; B29C 64/268; B33Y 10/00; B33Y 30/00; B33Y 40/00

(57) ABSTRACT

The invention relates to a process and an assembly for additive manufacturing of components by material extrusion, wherein the components are built up layer by layer from a component material which is applied in viscous state on top of a carrier. In the process, the component material applied in each case as a layer, while still in viscous state, is machined in synchrony with application with at least one laser beam directed onto a lateral boundary of the layer, preferably to achieve smoothing of unevennesses on surfaces of the component. The process allows manufacturing of components by material extrusion with reduced surface roughness even on non-visible surfaces, without any need for post-processing.

### TECHNICAL AREA

The present invention relates to a process and an assembly for additive manufacturing of components by material extrusion, wherein the components are built up one layer at a time from a component material which is applied in a viscous state on top of a carrier.

The technique of material extrusion (MEx) is the most widespread additive manufacturing technique in use today. The component material is typically fed in wire or granule form, heated to high temperatures and usually applied through a nozzle in molten or viscous state onto a carrier one layer at a time in order to build up the component. The most important advantages of this technology consist in the simple construction of the plant equipment, a wide selection of materials, and the freedom of design compared with conventional manufacturing technologies. The technique of material extrusion is therefore used for the manufacture of components in practically all branches of industry.

However, this technology also has drawbacks compared with conventional and other additive manufacturing processes. One of these disadvantages is the relatively rough surface of the manufactured components. Thus for example, with machining processes roughness averages (Ra) as low as 1 μm are achieved for turning and 1.5 μm for milling. In the case of components manufactured by material extrusion, the surface structure depends to a critical degree on the orientation of the component surfaces, the layer height of the individual layers, and the extrusion width. Roughness averages with average values of 20 μm are achieved, varying according to the contact angle. The surface structure that remains after the components are manufactured is caused primarily by the formation of steps due to the construction in layers and over-extrusion at the edges of the layers. Both effects can be mitigated but not entirely prevented by adjusting the process parameters. This often limits the technical use of components that are manufactured by material extrusion. Thus, smooth surfaces are needed in many application areas. The technique of material extrusion is consequently only used for the development of prototypes, and only rarely for industrial manufacturing.

### PRIOR ART

In order to create smooth surfaces on components that are manufactured by material extrusion, various post-processing techniques are known, for example mechanical post-processing by milling, turning or grinding. In the course of these machining processes, either the tool or the component performs a rotary motion, and the respective other component performs a linear advance movement. Various surface shapes and qualities can be achieved with corresponding NC programming. However, this post-processing process is time-consuming, particularly when it involves manual post-processing and complex components. This has the effect of diminishing the advantages of additive manufacturing. The technique of vibratory grinding, which is also known for post-processing, entails machining the component with loose abrasive grains. In this context, the abrasive grains and components are set in undefined motion relative to each other in a shared treatment space. By this process, the surface roughness on external surfaces of additively manufactured components can be reduced by as much as 80 to 90%. However, surface regions that are difficult to access are not adequately affected by the abrasive grains, so that surface roughness in these regions undergoes less reduction. Moreover, this process typically results in undesirable rounding at the component edges, the extent of which varies according to the treatment time and the shape of the abrasive grains. A further known process for mechanical post-processing of additively manufactured components is Blasting. In blasting, the component surface is treated by means of a pneumatically directed abrasive agent. This is a dry, granular material which is commercially available in an enormous variety of substance variant, grain sizes and grain forms. This is a simple process, but it only enables a small improvement in the surface quality.

Apart from these mechanical post-processing processes, other techniques, such as varnishing, metallising or chemical post-treatment, are also used to reduce the surface roughness of the manufactured components. In the case of varnishing, protective or decorative coatings are produced with the aid of fluid or powdered starting substances. For metallising, the components are furnished with a metallic coating material to improve their functionality and surface quality. However, the plastic surface of the components must undergo additional pretreatment in order to improve the adhesion of the metallisation thereto. Chemical post-treatment processes include pickling (dipping) and treatment with reactive gases (vaporisation). These chemical post-treatment processes are capable of realising a very good surface quality, even in non-visible and/or difficult to access surfaces. However, they often require the use of poisonous chemicals.

Another known option for post-processing the surfaces of additively manufactured components consists of laser machining, in particular laser polishing. Laser polishing is a thermal surface treatment process. The energy of the laser is used to melt or vaporise the material selectively. The success of a surface treatment in this case depends on the properties of the laser (wavelength, pulse characteristics, output power) and of the material that is to be processed. Examples of laser machining of the surfaces of components manufactured by means of material extrusion are described in the publications by M. P. Dewey et al., “Development of laser polishing as an auxiliary post-process to improve surface quality in fused deposition modeling parts”, Proceedings of the ASME 2017, International Manufacturing Science and Engineering Conference, pp. 1-5, or Y. Chai et al., “Laser polishing of thermoplastics fabricated using fused deposition modelling”, Int. J. Adv. Manuf. Technol. (2018) 96, pp. 4295 to 4302. However, with this technique it is only possible to process surfaces that are visible and can be accessed by the laser beam. Furthermore, each of the post-processing or post-treatment processes described above represent an additional process step, which prolongs the manufacturing time of the components.

US 2018/0117836 A1 discloses a process for additive manufacturing of components, in which the additive manufacturing can also be performed by means of material extrusion. In this context, in order to improve adhesion between the individual layers, each layer undergoes machining with one or more laser beams after application of the respective layer.

US 2018/0079136 A1 also suggests laser machining of a layer applied previously. According to this document, the respective surface is heated before each material separation.

DE 10 2018 108 145 A1 describes a process for treating surfaces of components produced by 3D printing, in which the components undergo post-treatment with laser radiation in a further process step after manufacturing to smooth the surface.

The problem addressed by the present invention consists in describing a process and an assembly for additive manufacturing of components by material extrusion, with which components having surfaces with low surface roughness even on non-visible sites may be obtained after building up the components layer by layer without the need for an additional process step.

### SUMMARY OF THE INVENTION

The problem is solved with the process and the assembly according to Claims 1 and 9. Advantageous variants of the process and of the assembly are objects of the dependent claims or may be discerned from the following description and the exemplary embodiments.

In the suggested process, the components are built up in known manner, one layer at a time from a component material which is applied—preferably through at least one extrusion nozzle—in viscous state layer by layer on top of a carrier, for example a substrate or baseplate. The process is characterized in that the component material applied in each case as a layer, while still in viscous state, is treated in synchrony with application with at least one laser beam directed onto a lateral boundary of the layer. This treatment is carried out preferably for the purpose of smoothing unevennesses on surfaces of the future component, which are created due to the layered construction method. In this context, these may be for example unevennesses that may be created by over-extrusion at the edges of the respective layers, or steps produced by the layered construction method. Said smoothing may be performed by material-shaping or material-removing laser machining, that is to say the shaping and/or removal of the extrusion material protruding at the edges and/or lateral boundaries of the layer in the case of over-extrusion and/or of the steps in the case of corresponding geometry of the component by the directed energy input with the laser parameters selected appropriately for this purpose. If necessary, a targeted surface structuring with synchronous laser machining may also be carried out instead of the smoothing.

A very wide variety of lasers may be used as energy source. The selection of the laser source depends critically on the material that is to be processed. Besides continuous wave (CW) lasers, use of pulsed lasers is also possible. Depending on the laser system selected, surface smoothing or surface structuring can be performed by several effects. On the one hand, the energy input may be selected such that the component material is heated locally to a temperature above its vaporisation temperature, resulting in removal of the material. On the other hand, a surface smoothing effect may also be induced by melting the material. Depending on the viscosity of the molten material, the contours of the component are then made fluid by the effects of surface tension. As a result, the roughness peaks are removed, and the roughness valleys are filled in. Both effects can be induced using an extremely wide range of laser types, as is known from the prior art of laser machining of surfaces. When pulsed lasers are used, the high-frequency laser pulses release additional vibrational energy in the applied layer or the applied component volume. At the same time, the micromelt generated due to the heat energy introduced by the material extruder and the laser system serves as a vibration barrier, by which vibrational energy is absorbed and converted into additional heat. This leads to the melting of the surface contour in fractions of a second.

An essential feature of the suggested process consists in that the lateral boundaries of the layer are treated by the one or several laser beams in synchrony with the material application of said layer, that is to say immediately after the application, while the component material is still in viscous state. In this way, the material applying extrusion process and the material moulding or material removing laser process constitute one common process step. Through the simultaneous use of multiple laser beams, in particular at least two laser beams beamed from opposite sides, which are thus directed simultaneously at opposing lateral boundaries of the layer, even surfaces on the future component that are not visible from the outside can be smoothed easily. In such a case, the laser beams are directed towards the lateral boundaries of the newly extruded layer portion transversely to the direction of extrusion. Depending on the geometry of the component, this is preferably carried out with laser beams which are beamed laterally, parallel to the plane of the layer. The laser beams may also be directed at an angle of preferably <45°, but particularly preferably <10° with respect to the plane of the layer. Ideally, the respective laser beam is directed towards the component material orthogonally to the surface region that is to be treated. Due to the synchronous treatment, less energy input is required for smoothing or surface structuring than is needed for post-processing of the finished component by means of laser radiation, since the viscous material is still at an elevated temperature.

The suggested process and the associated assembly are suitable not only for smoothing the surface of the respective completed component, but—as was explained earlier—also for additional structuring, which, in the same way as the smoothing, may then also be performed in the same process step as the material application. Moreover, the laser machining may also comprise a functionalisation of the surface, for example by activation of substances in the component material by means of the laser radiation. In this context, the energy input by the laser radiation initiates a chemical process, which in LAM (Laser Additive Manufacturing) for example can bring about curing of the silicon applied additively in this case.

The suggested assembly, which is designed to carry out the process, correspondingly includes an extrusion device by which the component material may be applied in viscous state one layer at a time on top of a carrier, and one or more laser machining devices. Said laser machining devices are arranged and designed such that, in synchrony with the material application through the extrusion device, they direct one or more laser beams from the side at each layer of component material as it is still in the viscous state. In this context, the laser machining devices may be attached directly to a positioning unit and/or kinematics system of the extrusion device, or they may also be independent of said kinematics. Depending on the configuration of the system, the one or more laser machining devices may be fixed in position, or also at least partially movable by means of their own kinematics. Thus for example, a fixed position assembly of the one or more lasers in conjunction with a kinematics system for a beam guidance part of the respective laser machining device is also possible. The arrangement and design of the laser machining device(s) only has to enable laser machining of the lateral boundaries of the respective layer region in synchrony with the material application.

With the implementation of the integrated laser machining process, smooth or structured surfaces on components manufactured by means of material extrusion can be produced directly during manufacturing with the process and the associated assembly. Compared with a downstream laser machining process, the surfaces are smoothed or structured immediately as they are created. Consequently, even internal smooth or selectively structured surfaces can be produced by means of laser machining. The process and assembly avoid costly, time-intensive post-processing of additively manufactured components with regard to the surface structure. Moreover, the suggested process and associated assembly make it possible to achieve higher build-up rates with greater layer thicknesses while maintaining consistent surface quality. In this way, the technique of material extrusion can be applied more economically.

The suggested process may be used with all additive material extrusion techniques, for example Fused Filament Fabrication (FFF), Fused Granular Fabrication (FGF), Direct Energy Deposition (DED), Liquid Additive Manufacturing (LAM), etc. The main application consists in the smoothing of component surfaces of additively manufactured components. In additionally, it is also possible for the surfaces to be functionalised or activated by means of said laser machining.

### BRIEF DESCRIPTION OF THE DRAWING

In the following text, the suggested process and the associated assembly will be explained again with reference to exemplary embodiments in conjunction with the drawing. In the drawing:

FIG. 1 is a schematic representation of two surface effects during material extrusion which lead to surface roughnesses;

FIG. 2 is a diagrammatic representation of the surface smoothing with the suggested process;

FIG. 3 is a diagrammatic representation of a first example of a construction of the suggested assembly; and

FIG. 4 is a diagrammatic representation of a second example of a construction of the suggested assembly.

### WAYS OF IMPLEMENTING THE INVENTION

In the course of the material extrusion additive manufacturing process, unevennesses occur on surfaces of the manufactured components, resulting in increased center roughness values on these surfaces. Said unevennesses may be attributed to two effects, which are illustrated in the schematic representation of FIG. 1. One of these effects is the formation of steps 7 as a consequence of the layer-by-layer construction. The subfigure on the left in FIG. 1 shows six layers 8 applied one on top of the other, with which in this cross-section a semicircular target contour 9 is to be created on the component. Here, the individual layers 8 are applied one after the other on top of a carrier 10 by means of material extrusion. The steps 7 are created by the layer thickness of the individual layers 8. Measured against the target contour 9, the dimensions of the step effect are inconsistent, with the result that the surface structure of the finished component is also correspondingly variable.

The subfigure on the right in FIG. 1 illustrates a different effect that leads to an uneven surface. This effect is caused by over-extrusion during application of the respective layer. This over-extrusion results in protruding beads 11 of the component material at the lateral boundaries or edges of the respective layers 8. The subfigure on the right in FIG. 1 also shows multiple layers 8 as well as the target contour 9 of the component. The extrusion nozzle 2 is indicated in outline above the layers 8.

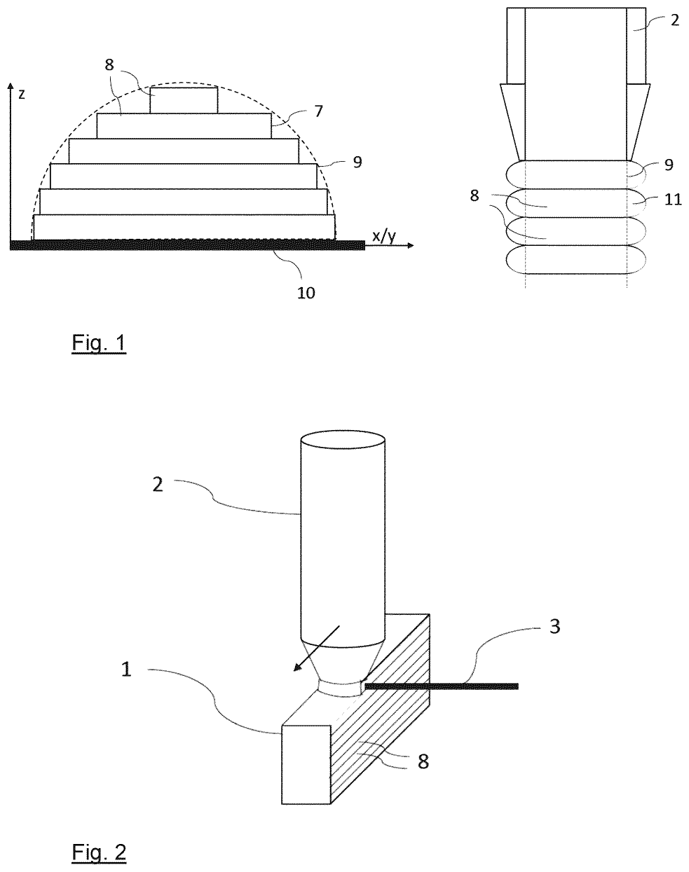

In the suggested process, the undesirable steps 7 and the beads 11 caused by over-extrusion may be removed and/or smoothed even while the component is being built up. This is assured during the material extrusion with an integrated laser unit for surface smoothing or surface structuring. The material applying extrusion process and the material shaping and/or material removing laser processes are synchronised and constitute a single, common process step. In this context, one or more laser beams 3 are directed towards the outlet of the extrusion unit, typically an extrusion nozzle 2, as is indicated schematically in FIG. 2. The laser beam 3 is aimed orthogonally with respect to the component surface that is to be smoothed in each case. Orthogonality is not necessary or possible in every case. Here, FIG. 2 shows diagrammatically that the component material of the respective individual layers 2 is already being treated with the laser beam 3 as it is applied, during the material extrusion. The direction of movement of the extrusion nozzle 2 is indicated by the arrow.

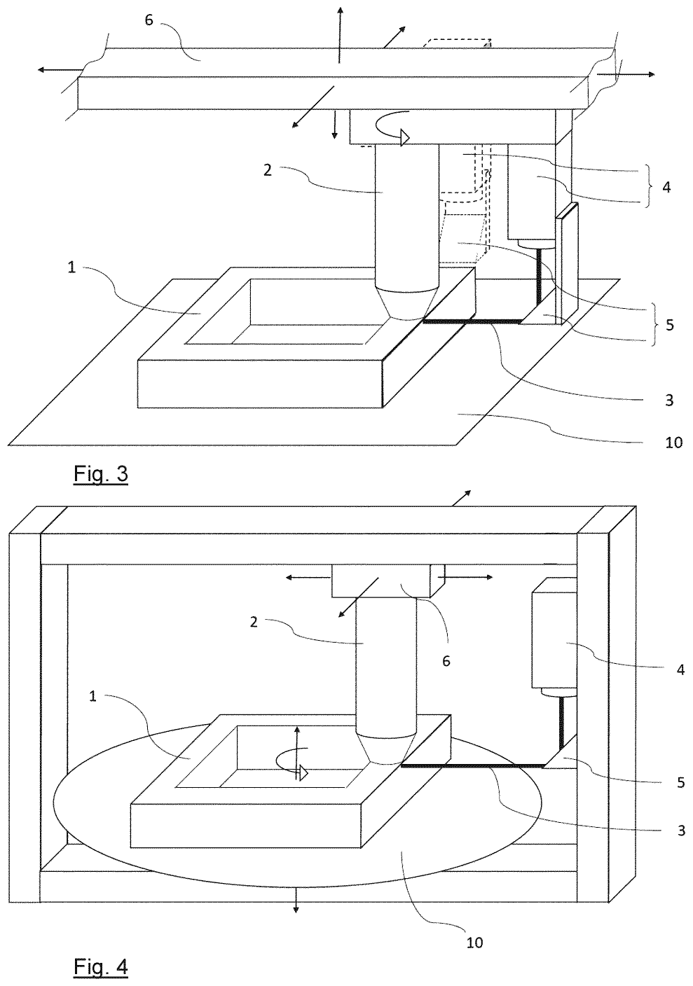

The requisite systems and devices for manufacturing according to the suggested process may be arranged in various ways. For example, FIG. 3 shows a first example of a possible variant of the suggested assembly. In this figure, the already constructed part of the component 1 is shown, on top of which further layers will be applied with the aid of the extrusion nozzle 2. The extrusion nozzle 2 is attached to a kinematics system 6, which enables a movement of the nozzle 2 in all three spatial directions (x, y, z), as is indicated by the straight arrows in the figure. This diagram also shows a laser device consisting of a laser 4 and a focusing unit 5, via which the laser beam 3 is redirected and aimed at the lateral boundary of the applied layer in synchrony with the material application. In this variant, the laser device is rotatable about the extrusion nozzle 2, as is indicated in the figure by the curved arrow. Additionally, one or several more such laser devices may also be arranged on the extruder and/or the kinematics system 6 for the purpose of treating each applied layer from multiple sides simultaneously. In all variants of the present invention, the option also exists to execute a scanning motion with the laser beam as needed, with the aid an additional scanning device.

Finally, FIG. 4 shows a further exemplary variant of the suggested assembly, in which the laser device consisting of laser 4 and focusing unit 5 are arranged separately from the extrusion device with extrusion nozzle 2 and kinematics system 6. In this example, a polar kinematics system is used, in which the carrier 10 with the component 1 rotates about a central axis. In this case, the extrusion nozzle 2 is attached to a further kinematics system, which enables movement of the extrusion nozzle 2 in the three spatial directions. The relative movement of the component due to the rotation of the carrier 10 means that all surfaces can be processed with just one laser device. Preferably however, this assembly includes at least two laser devices situated opposite one another, so that each applied layer can be processed simultaneously from both sides.

The assemblies represented in FIGS. 3 and 4 serve as examples only. The assembly, the configuration and the number of laser devices may also be varied in the same way as the arrangement and configuration of the extrusion device.

### LIST OF REFERENCE NUMERALS

1 Component
2 Extrusion nozzle
3 Laser beam
4 Laser
5 Focusing unit
6 Kinematic system
7 Steps
8 Layers
9 Target component contour
10 Carrier
11 Bead

1. Process for additive manufacturing of components by material extrusion, wherein the components are built up one layer at a time from a component material which is applied in viscous state layer by layer on top of a carrier,
characterized in that
the component material applied in each case as a layer, while still in a viscous state, is machined in synchrony with the material application with at least one laser beam directed onto a lateral boundary of the layer, so that material application and laser machining constitute a single, common process step.

2. Process according to claim 1,
characterized in that
the lateral boundary of the layer is at least partially shaped and/or removed by the laser beam.

3. Process according to claim 1,
characterized in that
the component material applied is melted and/or partially vaporised at the lateral boundary of the layer by the laser beam.

4. Process according to claim 1,
characterized in that
the machining with the laser beam is carried out in such manner that a smoothing of unevennesses on surfaces of the component that are caused by the layerwise construction is achieved.

5. Process according to claim 4,
characterized in that
unevennesses caused by over-extrusion and/or steps on the surfaces of the component caused by the layerwise construction are smoothed by the machining with the laser beam.

6. Process according to claim 1,
characterized in that
the laser beam is directed towards the lateral boundary of the layer at an angle of <45°, preferably <10°, with respect to a plane of the layer.

7. Process according to claim 1,
characterized in that
the manufacturing of the components is carried out with a system for material extrusion, in which one or more laser devices are integrated in order to generate the one or more laser beams.

8. Process according to claim 1,
characterized in that
the machining is carried out with at least two laser beams irradiated from opposite sides, which are directed towards opposite lateral boundaries of the layer.

9. Assembly for additive manufacturing of components by material extrusion, wherein the components are built up one layer at a time from a component material, with
an extrusion device, by which the component material can be applied in viscous state layer by layer to a carrier, and
one or more laser machining devices, which are arranged and designed such at they direct one or more laser beams laterally onto the component material applied as a layer still in viscous state in each case, in synchrony with the material application by the extrusion device, so that material application and laser machining constitute one common process step.

10. Assembly according to claim 9,
characterized in that
the laser machining device(s) is/are arranged and designed such that it/they direct(s) the laser beam(s) onto the lateral boundary of the layer at an angle of <45°, preferably <10°, with respect to a plane of the layer.

11. Assembly according to claim 9,
characterized in that
the laser machining device(s) is/are arranged and designed such that it/they direct the laser beams simultaneously at opposite lateral boundaries of the layer from opposite sides.

12. Assembly according to claim 9,
characterized in that
the extrusion device is equipped with a kinematics system, to which the one or more laser devices are also attached.

13. Assembly according to claim 9,
characterized in that
the one or more laser devices are arranged independently of a kinematics system of the extrusion device.
